(19) United States
(12) Patent Application Publication
(10) Pub. No.: US 2020/0078815 A1
(43) Pub. Date: Mar. 12, 2020

(54) CASING PROTECTING A WHEEL RIM BEING PAINTED FROM SCRATCHING AGAINST ELEMENTS OF AN AUTOMATIC PAINTING LINE, PRIOR TO PAINTING

(71) Applicant: DIPOL PLASTIC TECHNOLOGY Sp. z o.o., Jasionka (PL)

(72) Inventors: Sebastian Czarnik, Rzeszow (PL); Pawel Czarnik, Mrowla (PL)

(73) Assignee: DIPOL PLASTIC TECHNOLOGY Sp. z o.o., Jasionka (PL)

(21) Appl. No.: 16/227,197

(22) Filed: Dec. 20, 2018

(30) Foreign Application Priority Data
Sep. 12, 2018 (PL) W.127621

(51) Int. Cl. B05B 16/40

(52) U.S. Cl. CPC B05B 16/40

(57) ABSTRACT

A casing protecting a wheel rim being painted from scratching against elements of an automatic painting line, prior to painting, including a monolithic round shield (1) made of polyamide reinforced with glass fibres with a ring-like shoulder located vertically on its outer perimeter (2), and an outer hollowed profile shoulder (3) within the symmetry axis, created from a ring-like part (4) turning into a section of a truncated taper (5) closed in its upper end, and this ring-like shoulder (2), in its lower face (10), comes with at least three shoulders directed to the inside of this ring-like part of the shoulder (11) or (11′) which operate as latches evenly distributed on the circumference of the ring-like shoulder (2); and three cylindrical metal bars (12) protruding over its both surfaces will be sealed in this casing shield (1) to create an equilateral triangle profile with truncated vertices encompassing the profile shoulder (3).

### FIELD OF THE INVENTION

The subject of the utility model is a casing protecting a wheel rim being painted from scratching against elements of an automatic painting line, prior to painting, during wheel rim transfer through this line.

### BACKGROUND OF THE PRIOR ART

Within a recognised car wheel rim painting line, self-adjusting spindles for various types of aluminium wheel rims were used. Within painting lines, wheel rims are transferred through a system of synchronised, independent conveyor loops using handling robots equipped with special grippers to handle such rims.

In recognised and currently used solutions offered by the Durr company, in an automatic painting process, car wheel rims are transferred through an automatic line equipped with rims seats located within equal distances from one another. In these seats, wheel rims are located in a horizontal position and rest on their surfaces adjoining car wheel hubs and are centred by means of centring holes resting on tapered elements of the automatic line seats.

The inconvenience of this solution consists in the fact that, during transfer on an automatic line, the rim-hub contact surface is often subject to scratching and, additionally, line elements are covered with the paint applied on rims.

### SUMMARY OF THE INVENTION

The objective of the utility model is to develop a simple and universal single-element design of the casing to eliminate the above-mentioned inconveniences encountered during a recognised car wheel rim painting process on automatic painting lines.

The objective of the utility model is also to develop such a design of the protective casing which can be used both in an industrial scale, in automatic painting lines, and in typical automotive paint shops.

According to the utility model, the essence of the casing protecting a wheel rim being painted from scratching against elements of an automatic painting line, prior to painting, consists in the fact that it is created by a monolithic round shield made of polyamide reinforced with glass fibres with a ring-like shoulder located vertically on its outer perimeter, and an outer hollowed profile shoulder within the symmetry axis, created from a ring-like part turning into a section of a truncated taper closed in its upper end, and this ring-like shoulder, in its lower face, comes with at least three shoulders directed to the inside of this ring-like part which operate as latches evenly distributed on the circumference of the ring-like shoulder; and three cylindrical metal bars protruding over its both surfaces will be sealed in this casing shield to create an equilateral triangle profile with truncated vertices encompassing the profile shoulder.

It is beneficial when only one cylindrical metal bar protruding over its both surfaces is sealed in the casing shield and the shield has two two-sided rounded shoulders imitating this metal bar, which together create an equilateral triangle profile with truncated vertices.

It is also beneficial when the three cylindrical metal bars protruding from both shield surfaces and the single metal bar protruding from both shield surfaces with rounded shoulders protruding over surfaces of both these elements are situated within the same horizontal surfaces, but the three internal shoulders acting as latches constitute plate-like rectangular elements with equilateral triangle profiles in the cross-section.

### BRIEF DESCRIPTION OF THE DRAWINGS

FIG. 1 shows a perspective front view of a casing protecting a wheel rim being painted from scratching against elements of an automatic painting line, prior to painting, whose round shield comes with three metal bars sealed in it;

FIG. 2 shows a bottom view of the casing of FIG. 1;

FIG. 3 shows a cross sectional view of the casing along line A-A of FIG. 2;

FIG. 4 shows a perspective front view of the casing having a round shield with one metal bar sealed in it;

FIG. 5 shows a bottom view of the casing of FIG. 4;

FIG. 6 shows a cross sectional view of the casing along line B-Bi of FIG. 5; and

FIG. 7 shows an example of using the casing within an automatic painting line presenting, in a vertical section, a fragment of a production-painting line with the protective casing seated on its retaining element, on the profile shoulder of which a fragment of a painted wheel rim is placed.

### DETAILED DESCRIPTION OF THE INVENTION

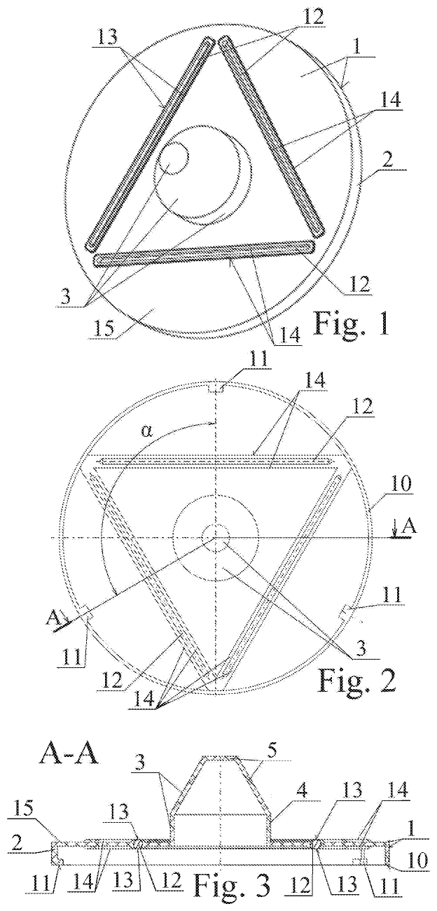

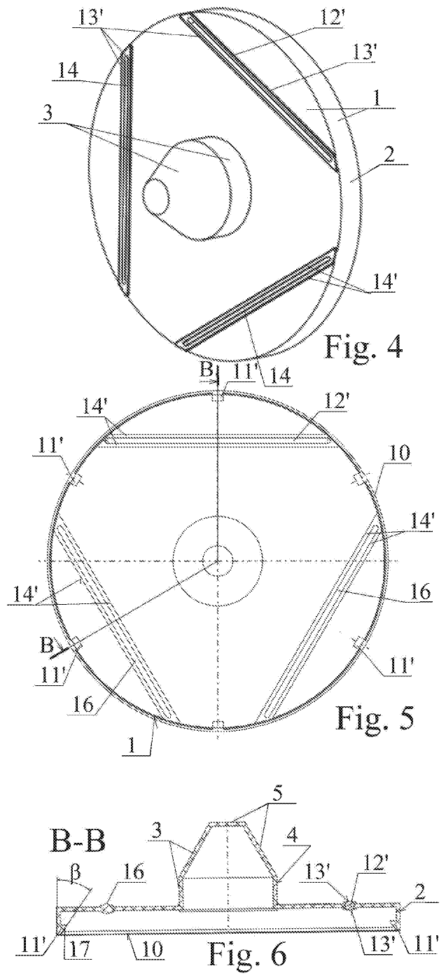

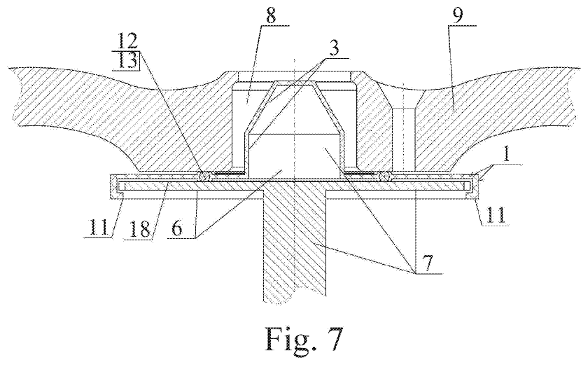

The subject of the utility model in its two form variants having the same significant technical features is shown in the drawing in which FIG. 1-3 show the first form of this model with three metal bars sealed in its round shield, FIG. 4-6 show the other form of this model with one metal bar sealed in its round shield, where FIG. 1 shows a casing protecting a wheel rim being painted from scratching against elements of an automatic painting line, prior to painting, whose round shield comes with three metal bars sealed in it, in a perspective view, FIG. 2 shows the same casing in a bottom view, FIG. 3 shows the same casing in the vertical section along the A-A line, FIG. 4 shows the same casing whose round shield has one metal bar sealed in it, in a perspective view, FIG. 5 shows the same casing in the bottom view, FIG. 6 shows the same casing in a section along the B-B line and FIG. 7 shows an example of using one of these casing variants within an automatic painting line presenting, in a vertical section, a fragment of a production-painting line with the protective casing seated on its retaining element, on the profile shoulder of which a fragment of a painted wheel rim is placed.

The protective casing in its first form variant shown in FIG. 1-3 consists of a round shield (1) with a ring-like shoulder (2) located on its circumference and the outside hollowed profile shoulder (3) within its symmetry axis, created from a ring-like part (4) turning into a part of a truncated cone (5) closed on its top, and the profile of the outside shoulder (3) is adjusted to the profile of the painting line (7) retaining element (6) and the axial hole (8) of the wheel rim (9) being painted.

Apart from this, the outside ring-like shoulder (2) of the round shield (1) of this casing has three inside rectangular plate-like shoulders (11) on its lower face (10) which are evenly distributed on the circumference at an angle of 0=120° which function as latches, however, this shield made of polyamide reinforced with glass fibres comes with three cylindrical metal rods (12) sealed in it, and their opposite rounded surfaces (13) protrude over two-sided rectangular shoulders (14) of this shield which together create an equilateral triangle profile with truncated vertices encompassing the profile shoulders (3) of the round shield (1), and, on the outer surface (15) of this round shield, these shoulders together with the rods (12) sealed in them do not reach its circumference.

On the other hand, the protective casing in the form shown in FIG. 4-6 has an identical shape and design as the first form (FIG. 1-3), and the only difference between both forms consists in the fact that both surfaces of this shield (1) also come with three rectangular shoulders (14) forming an equilateral triangle profile with truncated vertices whose ends touch the shield circumference, but in only one of these shoulders (14′) a single cylindrical metal rod (12′) is sealed and its opposite rounded surfaces (13′) protrude in front of these two-sided rectangular shoulders (14′), and rounded elements (16) made from the same plastic as the shield (1) and imitating the cylindrical metal bar (12′) protrude from the remaining two rectangular shoulders (14′), on their both sides and along their entire length. In turn, the outside ring-like shoulder (2) of the shield (1) has, on its lower face (10), a truncated inside edge (17) set at an angle of □=30° plus three inside shoulders (11′) of an equilateral triangle profile in the vertical section also functioning as latches, located on its circumference and partially on the inside surface of this shoulder.

Moreover, in both form variants of this casing, all three cylindrical metal bars (12) sealed in the rectangular shoulders (14) of the round shield (1) or one cylindrical metal bar (12′) sealed in the same rectangular shoulder (14′) of this shield and both rounded elements (16) constituting the shoulders of the two remaining rod-like shoulders (13′) are located on one horizontal plane, and these cylindrical metal bars transfer electric charges from automatic painting line (7) components to a wheel rim (9) being painted and these charges ensure that paint is attracted to a wheel rim and, simultaneously, protect these line components against contamination with the paint. Moreover, as shown in FIG. 7, the lower part of the protective casing is seated on the round retaining element (6) of the painting line (7) so that its three protrusions (11) or (11′) functioning as latches are permanently seated on this element, and a wheel rim (9) is seated on the outside profile shoulder (3) of the round shield (1) of this casing, as a result of which the shield functions as a spacing element between the wheel rim and retaining element (6) of the painting line (7).

1. A casing protecting a wheel rim being painted from scratching against elements of an automatic painting line prior to painting, the casing comprising:
a monolithic round shield (1) made of polyamide reinforced with glass fibres with a ring-like shoulder located vertically on an outer perimeter (2), and an outer hollowed profile shoulder (3) within a symmetry axis, the monolithic round shield is made from a ring part (4) turning into a section of a truncated taper (5) closed in an upper end, and the ring-like shoulder (2), in a lower face (10), has at least three shoulders directed to an inside of the ring part of a shoulder (11) or (11′) which operate as latches evenly distributed on the circumference of the ring shoulder (2); and three cylindrical metal bars (2) protruding over both surfaces are sealed in the casing shield (1) to create an equilateral triangle profile with truncated vertices encompassing the shoulder (3).

2. The casing according to claim 1, wherein in the casing includes only one cylindrical metal bar (12′) protruding over both surfaces is sealed in the monolithic round shield (1) and the monolithic round shield has two two-sided rounded shoulders (16) imitating the metal bar, which together create an equilateral triangle profile with truncated vertices.

3. The casing according to claim 1, the casing includes three cylindrical metal bars (12) protruding from both shield (1) surfaces and the single metal bar (12′) protruding from both shield surfaces, together with rounded shoulders (16) protruding over surfaces of both these elements are situated within the same horizontal planes.

4. The casing according to claim 1, wherein the internal shoulders (11) acting as latches constitute plate-like rectangular elements.

5. The casing according to claim 1, wherein the internal shoulders (11′) acting as latches have equilateral triangle profiles in the cross-section.
